(19) United States
(12) Patent Application Publication
(10) Pub. No.: US 2026/0210162 A1
(43) Pub. Date: Jul. 23, 2026

(54) Seamless Door Latch

(71) Applicant: SCUDDER Enterprises, Fort Worth, TX (US)

(72) Inventor: Curtis D. Gardner, Fort Worth, TX (US)

(73) Assignee: SCUDDER Enterprises, Fort Worth, TX (US)

(21) Appl. No.: 19/190,935

(22) Filed: Apr. 28, 2025

Related U.S. Application Data
(60) Provisional application No. 63/639,654, filed on Apr. 28, 2024.

(51) Int. Cl. E05C 1/16; A01K 1/00; E06B 3/70

(52) U.S. Cl. CPC E05C 1/16; A01K 1/0017; E06B 3/7009

(57) ABSTRACT

A seamless horse stall dutch door latch having a latch slide biased to normally closed by a spring, connected to a dead bolt, the latch slide containing a recess which can be slide between a normally closed position, with the spring uncompressed and the deadbolt engaged with a strike plate, and a normally open position, with the slide moved to compress the spring and the deadbolt unengaged with the strike plate.

### CROSS-REFERENCE TO RELATED APPLICATIONS

This application claims priority to provisional application number 63/639,654, filed Apr. 28, 2024, the entire contents of which is hereby incorporated by reference.

### FIELD OF THE INVENTION

The invention relates to a door latch and more specifically to a seamless door latch for a horse stall or barn door, and specifically a dutch door.

### BACKGROUND OF THE INVENTION

Animal stall doors, or barn doors, including dutch doors, require a door latch to securely lock them in the closed position. Previous door latches can be opened by animals and/or are not safe, as the animals can scrap against them and be injured. What is needed is a door latch which can securely latch the door closed, but which is safe for the animals when the door is open.

### SUMMARY OF THE INVENTION

A seamless horse stall dutch door latch is provided which doesn't injury a horse, having a latch slide biased to normally closed by a spring, connected to a dead bolt, the latch slide containing a recess which can be slide between a normally closed position, with the spring uncompressed and the deadbolt engaged with a strike plate, and a normally open position, with the slide moved to compress the spring and the deadbolt unengaged with the strike plate.

In a preferred embodiment, latches are provided in a dutch door having an upper door with the latch and a lower door with a second latch.

A person opens the latch by sliding the latch slide away from the strike plate, to compress the spring and disengage the deadbolt from the strike plate.

A person closes the latch by releasing the latch slide to allow the spring to uncompress, causing the deadbolt to engage with the strike plate.

### BRIEF DESCRIPTION OF THE DRAWINGS

FIG. 1 is a view showing a horse stall dutch door with the upper and lower door sections having the inventive seamless door latch.

FIG. 2 is a front view of the door latch in a fully recessed position.

FIG. 3 shows the latch slid away from the strike plate, to open the door.

FIG. 4 shows the latch in its normal position, with the deadbolt engaged.

### DETAILED DESCRIPTION OF THE INVENTION

While this invention may be embodied in many forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

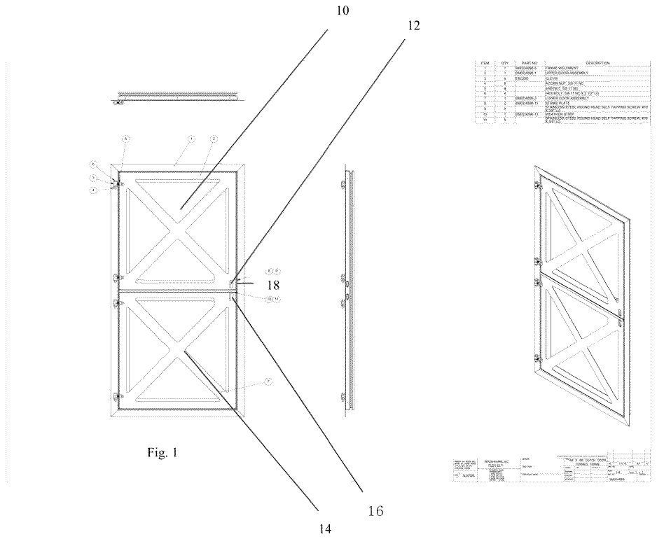

FIG. 1 is a view showing the horse stall dutch door having an upper door section 10 with a first seamless door latch 12, engaged to a strike plate 18 and a lower door section 14 with a second seamless door latch 16.

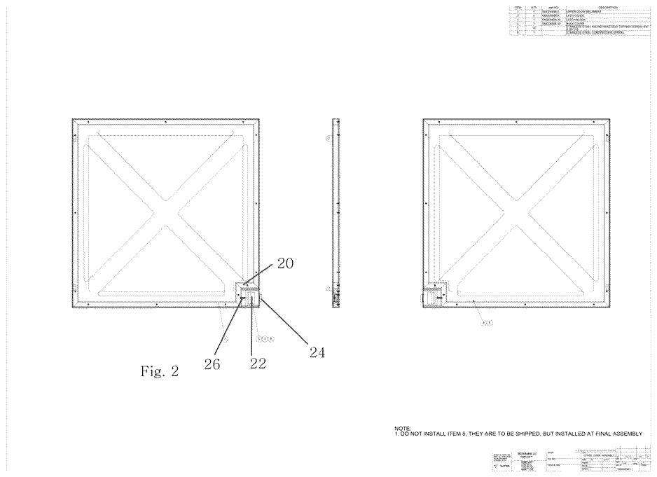

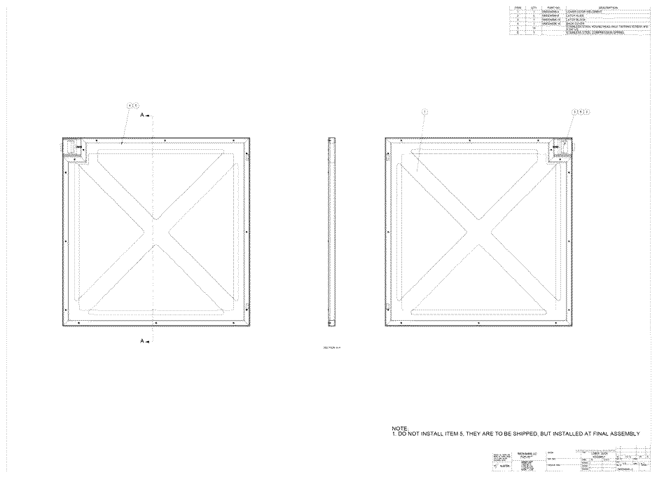

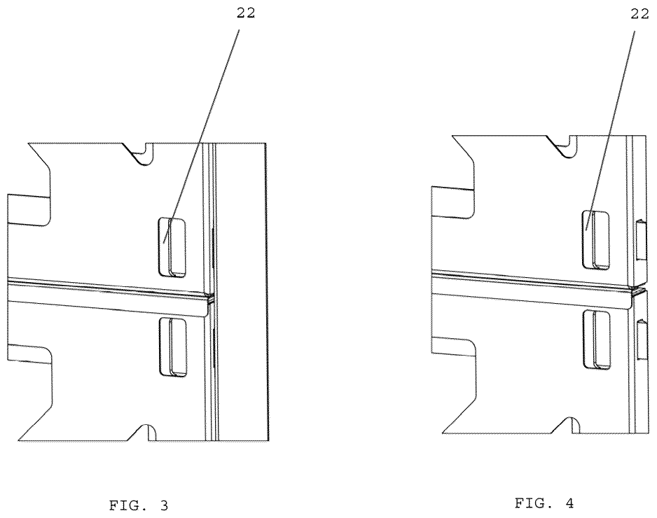

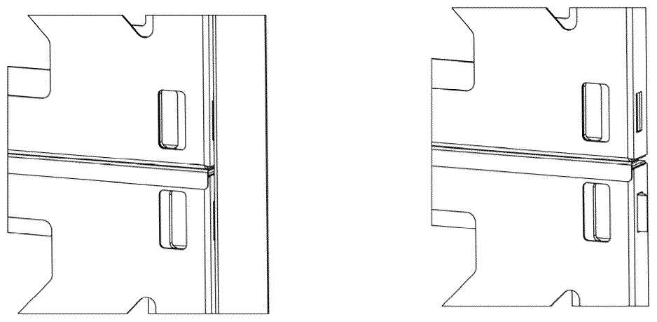

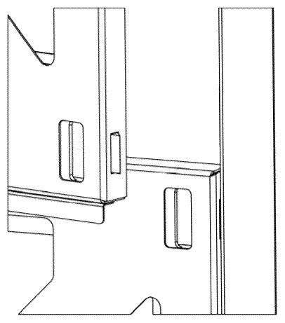

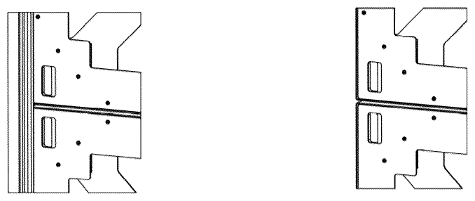

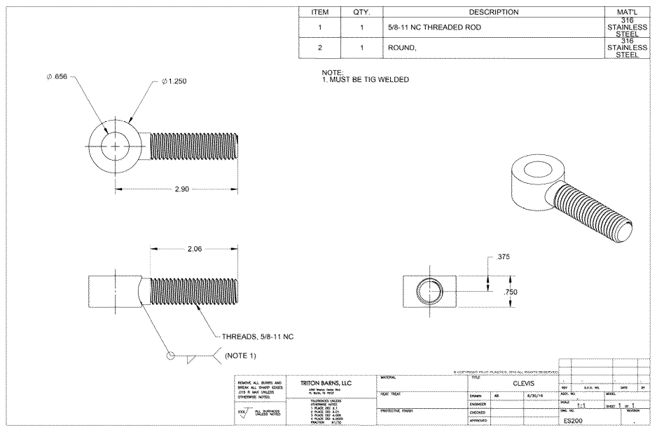

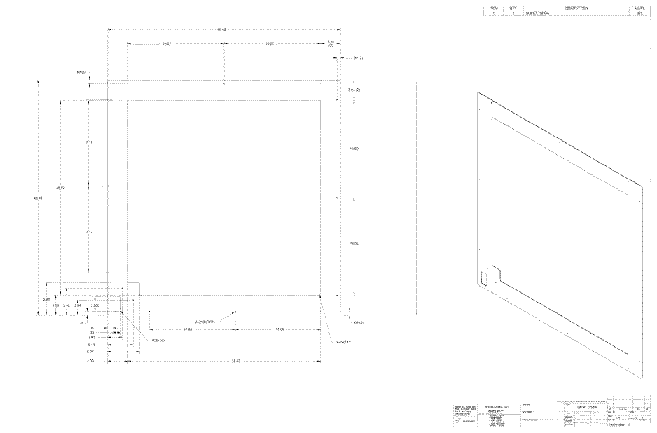

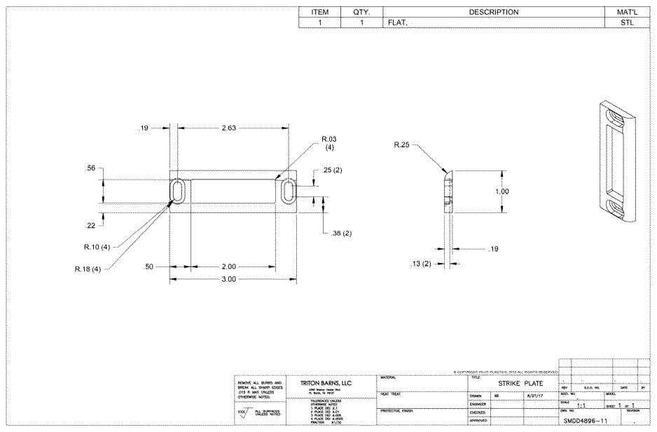

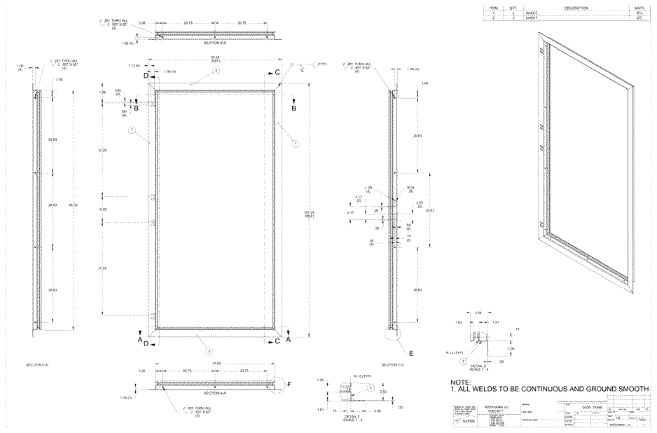

FIG. 2 shows the seamless door latch in more detail, with a latch block 20, which includes a latch slide 22 carrying a deadbolt 24 and a compression spring 26. The latch slide 22 has a recess accessed through an opening in the slide block, which is used to slide the slide block 22 away from the strike plate 18, to compress the spring and disengage the deadbolt from the strike plate, allowing the door to be swung open. When the latch slide is released, the compression spring slides the latch slide back towards the strike plate and causes the deadbolt to re-engage with the strike plate.

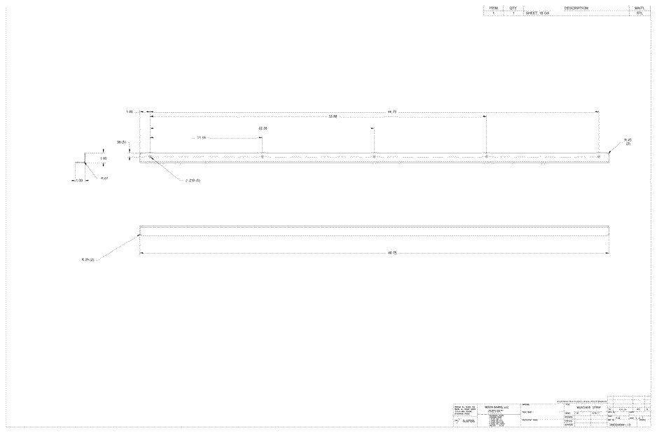

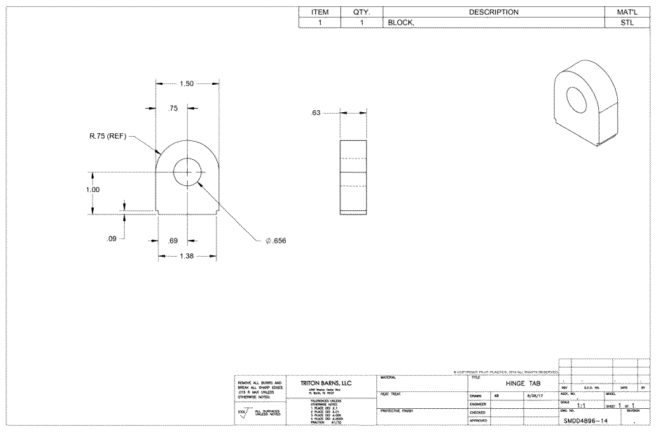

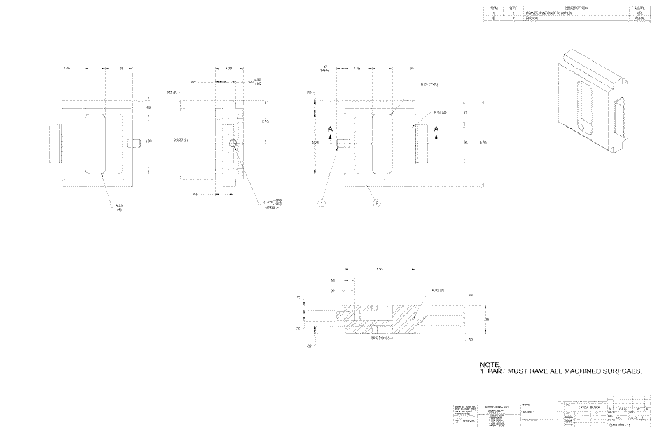

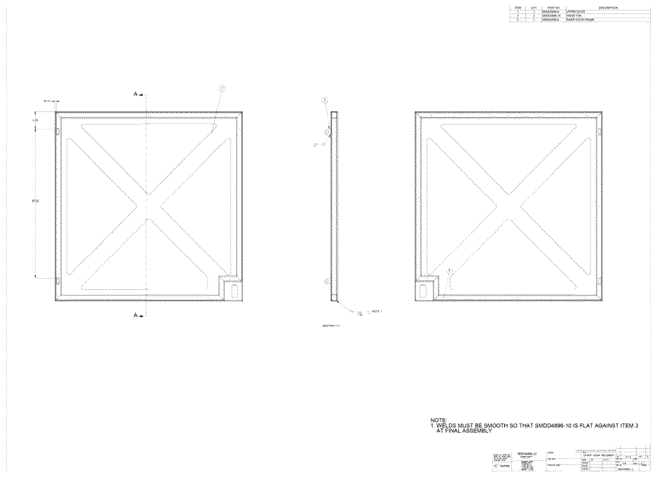

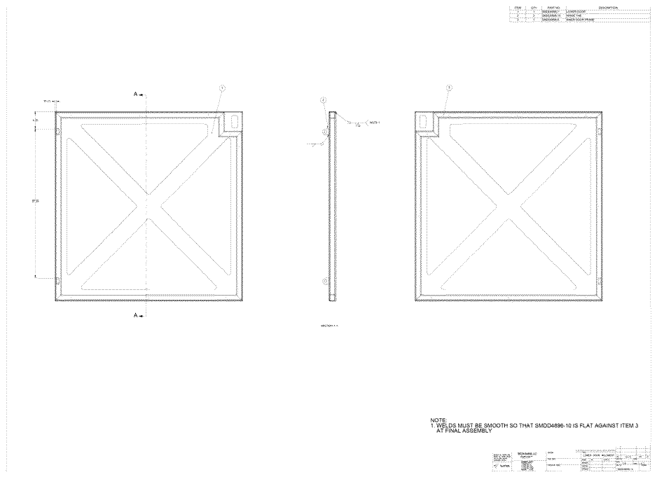

FIG. 3 shows the latch 22 slid away from the strike plate, to open the door.

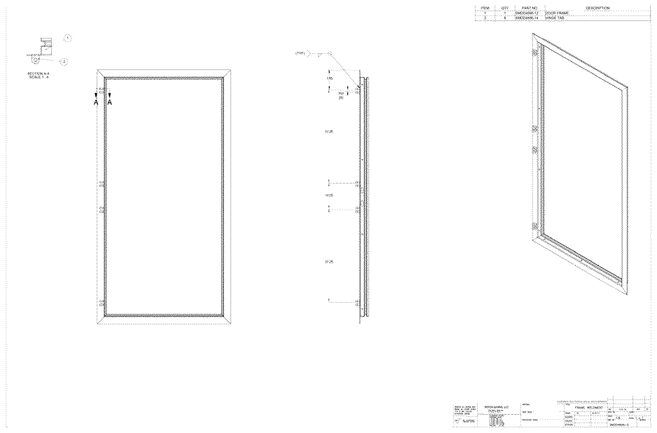

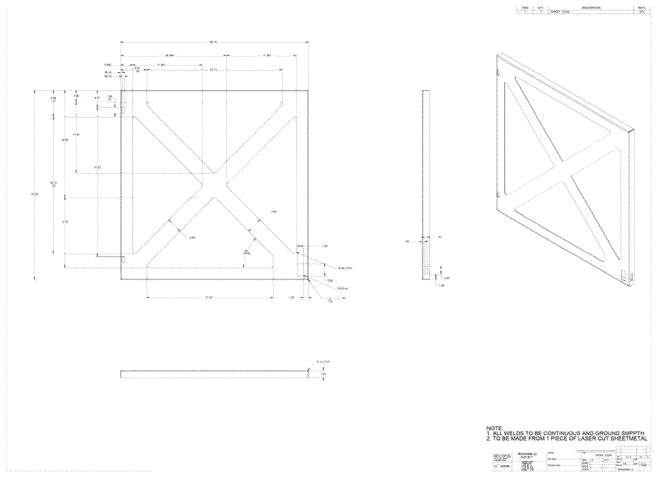

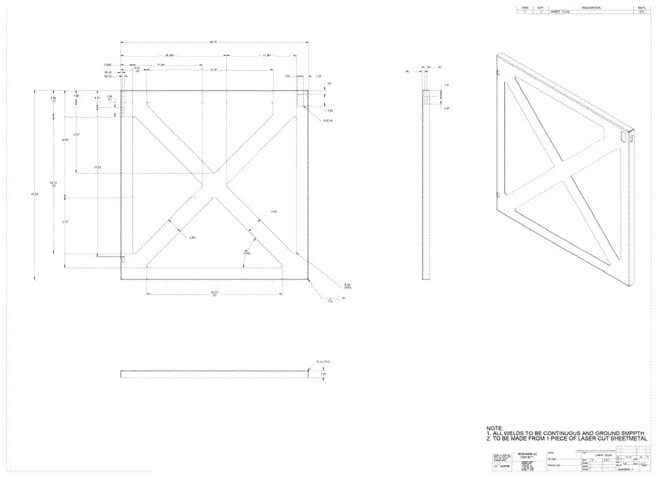

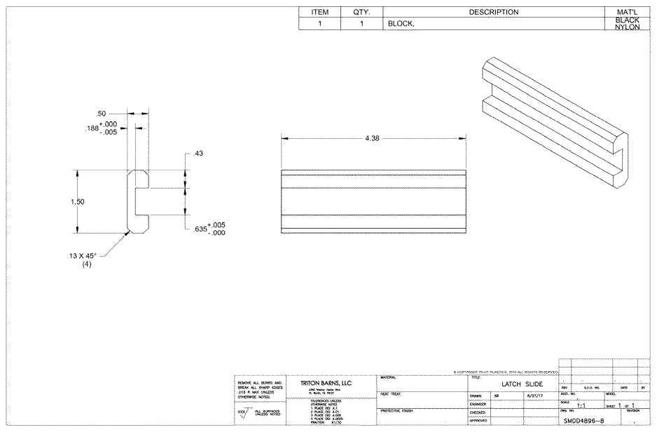

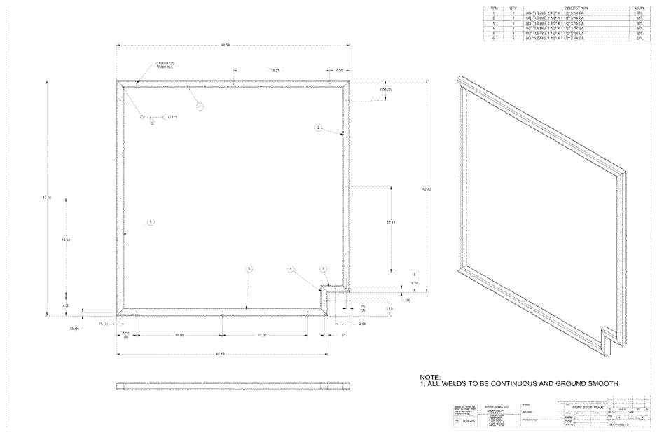

FIG. 4 shows the latch 22 in its normal position, with the deadbolt engaged.

1. A seamless horse stall dutch door latch comprising:
a latch slide biased to normally closed by a spring, connected to a dead bolt, the latch slide containing a recess which can be slide between a normally closed position, with the spring uncompressed and the deadbolt engaged with a strike plate, and a normally open position, with the slide moved to compress the spring and the deadbolt unengaged with the strike plate.

2. The seamless horse stall dutch door latch of claim 1 in combination with a dutch door having an upper door with the latch and a lower door with a second latch.

3. The seamless horse stall dutch door latch of claim 1 where a person opens the latch by sliding the latch slide away from the strike plate, to compress the spring and disengage the deadbolt from the strike plate.

4. The seamless horse stall dutch door latch of claim 1 where a person closes the latch by releasing the latch slide to allow the spring to uncompress, causing the deadbolt to engage with the strike plate.
